(19) United States
(12) Patent Application Publication
(10) Pub. No.: US 2001/0040911 A1
(43) Pub. Date: Nov. 15, 2001

(54) Wine thermometer

(75) Inventor: Scott Rubenstein, Bedford, NH (US)

Correspondence Address: Norman P. Soloway, Hayes, Soloway, Hennessey, Grossman & Hage, 175 Canal Street, Manchester, NH, 03101, US

(73) Assignee: Brookstone Company, Inc.

(21) Appl. No.: 09/734,993

(22) Filed: Dec. 12, 2000

Related U.S. Application Data
(60) Provisional application No. 60/170,321, filed on Dec. 13, 1999.

(51) Int. Cl. G01K 1/14; G01K 13/00; G08B 21/00

(52) U.S. Cl. 374/141; 374/155; 340/586; 340/584

(57) ABSTRACT

An electronic wine thermometer comprises a housing having a temperature probe extending from the housing. A display panel is associated with the housing and interactive with operational circuitry contained within the housing. A heat sensor is located in the probe, and is in electronic communication with the operational circuitry completing the device is a cork extractor mounted on the housing.

### FIELD OF THE INVENTION

This invention relates to a temperature measuring device and more particularly to a thermometer for measurement of temperature of wine just prior to serving. In one embodiment the thermometer includes an electronic information database which stores optimal serving temperature of various types of wine. In a further embodiment, the wine thermometer and information database is incorporated into a device which simultaneously provides a wine removing mechanism (corkscrew) thereby affording a unique and convenient consumer device for testing wine for appropriate serving temperature, prior to opening a selected wine bottle.

### BACKGROUND OF THE INVENTION

Wine connoisseurs know that the temperature of wine can make a considerable difference in taste and enjoyment and vineyards are responding by listing the correct temperature on most new labels. Serving wine too cold reduces its aroma and flavor, and highlights any bitterness. Serving the wine too warm can make the flavors unpleasantly dull and flat, and the wine seem harshly alcoholic.

Various attempts have been reported to address this problem. For example, U.S. Pat. No. 3,864,976 discloses a liquid crystal strip or band thermometer that may be attached to a bottle with an elastic strip. In related context, U.S. Pat. No. 5,304,003 discloses a liquid crystal strip thermometer that is adhesively attached to an aquarium for viewing through the glass and water. More specifically directed to wine bottle temperature is U.S. Pat. No. 4,538,926 which discloses a single liquid crystal composition that changes color with temperature and a comparison band with which the color can be compared. A symbol in the comparison band indicates the exact temperature for serving the wine in the bottle to which the device is attached.

U.S. Pat. No. 5,738,442 reports on a new wine thermometer for indicating the temperature of a bottle of wine, using liquid crystal technology. The wine thermometer comprises a thin patch adhesively attached to the bottle exterior. With tight adhesive attachment the temperature of the bottle and the wine within can be quickly and accurately determined without damaging the contents.

Attention is also directed to U.S. Pat. No. 4,681,611 which relates to a process and a device for insuring that wine which is being drunk from a glass is at substantially a predetermined temperature.

Accordingly, it is an object of the invention herein to improve upon prior art techniques and provide the consumer with a more convenient and accessible device for checking and ensuring that wine is at the appropriate temperature.

### SUMMARY OF THE INVENTION

In a first embodiment, the present invention relates to a device and associated process wherein a wine thermometer is employed which thermometer is supplied together with an electronic information database which stores optimal serving temperature of various types of wine. A thermometer or thermocouple probe of elongated nature is supplied, preferably made from stainless steel or other appropriate material suitable for use as a temperature probe, which probe can be inserted through the mouth of the wine bottle and into the wine to ascertain the temperature of the wine therein. This temperature is then reported to a database, which contains in memory optimal temperatures for serving various wine types, which wine types can be selected by the user. Accordingly, the database herein can store and be readily programmed with a variety of optimal serving temperatures for numerous types of wines, depending only upon the memory capability of the database installed therein.

For example, a preferred temperature of about 34-41° F. is known as an optimum temperature for “sweet wines”, 44-53° F. for “young dry whites” and 52-61° F. for “aged dry whites”. Accordingly, in the event that the consumer is checking the temperature of a “young dry white” wine, such temperature requirement is indicated to the consumer by way of a visual panel, and the temperature of the wine is reported relative to such required temperature, so that the consumer is aware, whether or not the wine is at optimum serving temperature, and if necessary, cool or warm the wine. Accordingly, in the context of the present invention, a plurality of optimum wine serving temperatures are stored in the wine temperature probe database, and the consumer can select and properly ascertain when the appropriate serving temperature has been achieved.

Furthermore, in accordance with the present invention, when the thermometer or thermocouple is reporting an optimum serving temperature, the device preferably contains a visual or sound (beeping) indication that acceptable temperature has been achieved. For example, the device preferably contains three visual indicating lights, which can be labeled “warm”, “optimum” and “cool”, with respect to a given wine selected for testing. In such manner, when the “optimum” temperature is present, the device reports such to the consumer by such visual light indication, or “green” light. Alternatively, when the wine is not at optimum temperature, or is too warm or too cool, the device similarly reports such to the consumer, again by a visual detection means, such as by the use of “red” indicating lights.

In a further embodiment, a wine thermometer and information database is incorporated in a device which simultaneously provides a cork removing mechanism such as a corkscrew or a pressure or pump type cork extractor, a foil cutter, etc., thereby affording an ever more unique and convenient consumer device for testing wine for appropriate serving temperature. In a preferred embodiment, a corkscrew is attached to the wine thermometer device in such a manner that it can be folded into the device such that the corkscrew does not interfere when the thermometer probe is inserted in the wine for testing.

### BRIEF DESCRIPTION OF THE DRAWINGS

Further features and advantages of the present invention will be seen from the following detailed description, in which

FIG. 1 is a top plan view showing one embodiment of a temperature measuring device in accordance with the present invention;

FIG. 2 is a side elevation from one side;

FIG. 3 is a view, similar to FIG. 2, from the other side;

FIG. 4 is a schematic illustration of the operational circuitry of a device in accordance with the present invention;

FIG. 5 is a data flow chart incorporating the operational data channel circuitry of the present invention;

FIG. 6 is a view, similar to FIG. 1, and showing an alternative embodiment of the present invention; and

FIG. 7 is a view, similar to FIG. 1 (but in partial cross-section) and showing yet another alternative embodiment of the present invention.

### DETAILED DESCRIPTION

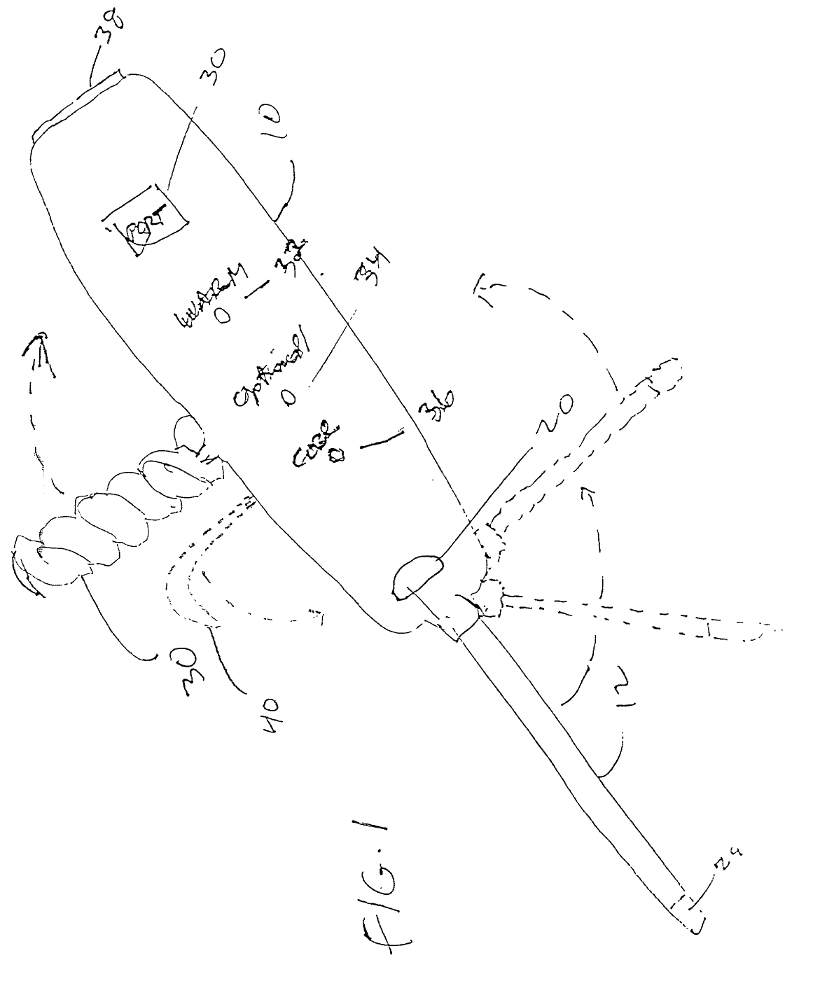

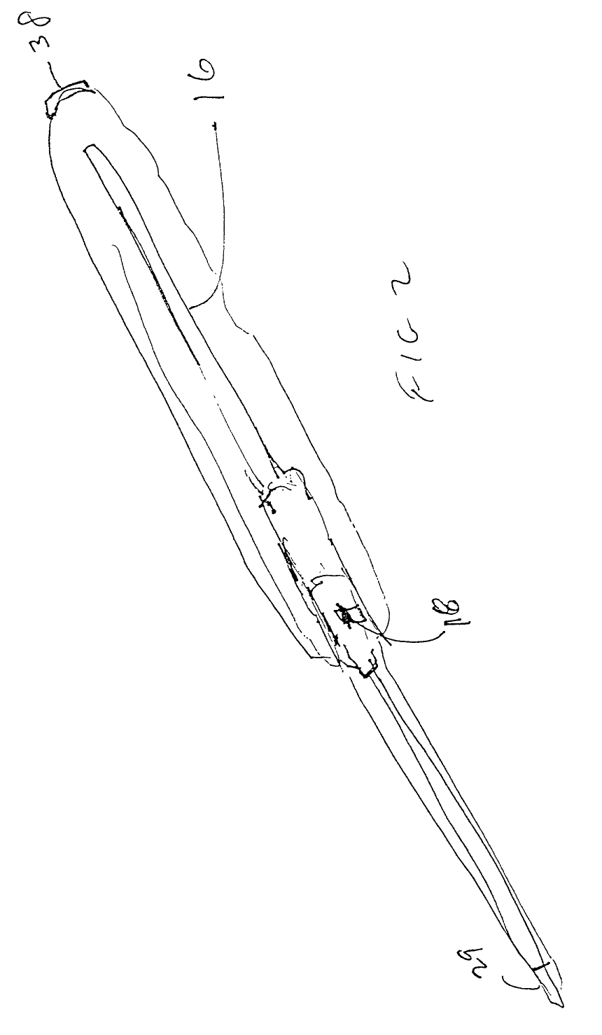

With reference to the accompanying drawings, the electronic wine thermometer and cork screw of the present invention preferably comprises a generally rectangularly shaped housing 10 sized for ease of handling by the consumer. The device contains an elongated temperature probe 12 which is pivotally mounted to one end of the housing 10 by a rotatable hub or mount 14 which permits the temperature probe to be rotated inwardly and therein fold into the device in a groove 16 formed along one side wall of housing 10. In other words, as shown in FIG. 1, probe 12 readily can be rotated from an open, operational position (as shown in solid line) in a generally counter-clockwise fashion (shown in phantom) to fold within groove 16. (FIG. 2). In such fashion, the probe 12 can be safely stored within housing 10 when not in use. Preferably mount 14 includes a first detent (not shown) for engagement with a spring locking device (not shown) for locking the probe in an open, operational position, and a second detent 18 for locking the probe in a closed, storage position. A release mechanism 20 is provided in the housing 10 for releasing probe 12 from its stored position, and may include a spring or cam surface for urging probe 12 from groove 16 sufficient so that the probe may be grasped and pivoted to its open, operational position.

Housing 10 also includes a wine selection display including a word display panel 30 and a degree or drinking temperature indicator display panel 26.

Probe 12 is in electronic communication with operational circuitry within the housing 10. The latter communication is along and through mount 14 which also provides rotational mounting support for the probe 12. Probe 12 includes a temperature sensor 29, typically at or near the probe tip. Internal transfer components (not shown), communicate data corresponding to wine temperature at sensor 29 to the housing 10 and circuitry associated with it. These data are received by the operational circuitry of the device as input from the sensor when within the wine.

The display preferably also includes discrete display areas. Typically, these display areas operate in accordance with LCD technology which provides visible indicia that vary as needed. In the illustrated embodiment, the display has a word display area 30 which has indicia components which spell a word or an abbreviation in order to indicate the type of wine or provide some other word indicator. In the illustrated embodiment word area of display 25 is activated to display one of the following word designations: PORT; ROSE; CHARD; CABER; MERLO; CHNTI; ZINFN; PINOT; BORD; BURG; CHAMP. In the preferred embodiment, these word designations appear in the ordered sequence given above upon appropriate manipulation of a component at a control interface, such as a control button or key actuator 38 at one end of the device. It will be appreciated that this word sequence repeats itself upon continued manipulation. Thus, PORT follows ROSE, and so forth.

Discrete LED/word areas 32, 34, and 36 also are included within the display. One of an array of words is highlighted. The words of the illustrated embodiment are: WARM; OPTIMAL; and COOL. In the embodiment shown in the drawings, each word is associated with a light indicator of a LED type. Other approaches are possible, including having the wordings be within an LCD display or the like. When provided, the light indicators can be of different colors to help readily distinguish among the different wordings.

When the probe sensor 12 is inserted within the wine, one of these wordings illuminates or is otherwise made readily visible, and this indicates whether the wine is at optimal drinking temperature, too warm or too cool for the selected wine.

When a temperature is registered at the sensor inserted into the wine, the appropriate area or signal will be illuminated or given. In the illustrated embodiment, a light will illuminate. Preferably, the illuminated light will flash to help draw attention to the temperature achieved for the selected wine type.

Reference will now be made to preferred temperature correlations for selected wine types. These values typically are programmed into the memory of the operational circuitry in accordance with Table I:

TABLE I
Temperature Triggers (° F.)

| | Cool is below | Optimum is | Warm is Above |
|---|---|---|---|
| Rose | 43 | 44-58 | 59 |
| Chardonnay | 39 | 40-54 | 55 |
| Port | 60 | 61-75 | 76 |
| Cabernet | 55 | 56-69 | 70 |
| Merlot | 55 | 56-69 | 70 |
| Chianti | 55 | 56-69 | 70 |
| Zinfandel | 39 | 40-54 | 55 |
| Pinot | 55 | 56-69 | 70 |
| Bordeaux | 55 | 56-69 | 70 |
| Red Burgundy | 55 | 56-69 | 70 |
| Champagne | 36 | 37-51 | 52 |

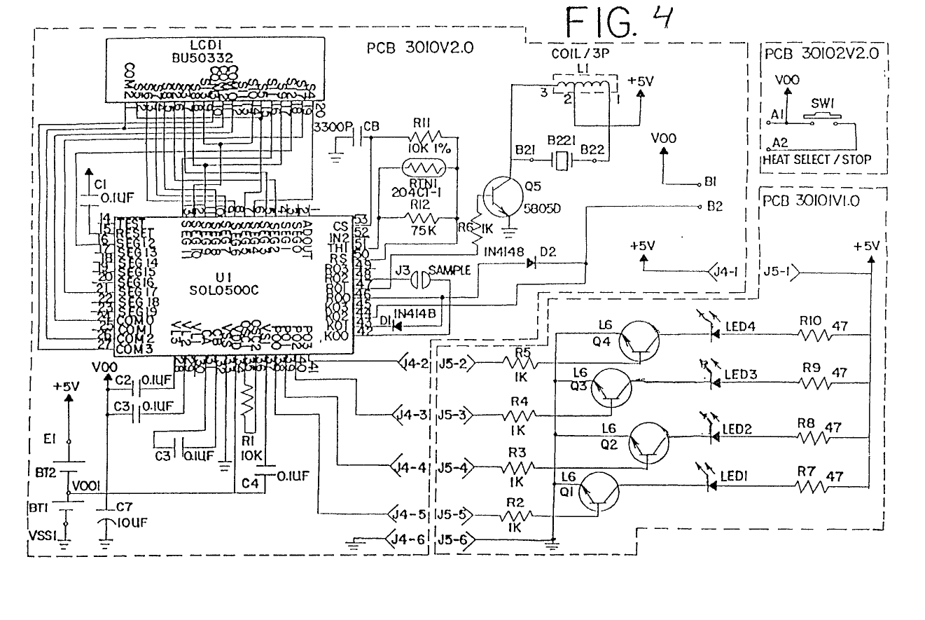

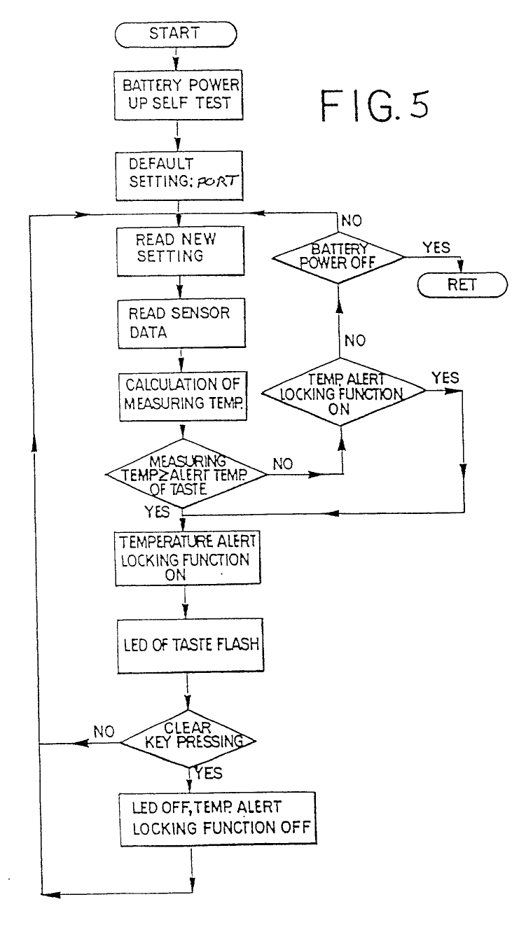

Specifics concerning operation of the preferred embodiment of the wine thermometer are now provided. It will be appreciated that details of this operation are illustrated with particularity in FIGS. 4 and 5. These are to be understood to be in accordance with the illustrated preferred embodiment. Variations in the schematic shown in FIG. 4 and in the flow chart shown in FIG. 5 may be employed in order to accommodate desired operational variations which may be discussed herein or which may be otherwise appropriate within the scope of the invention.

In initiating operation of the illustrated embodiment, a power source such as a battery is energized or is placed with the housing 10 through a door (not shown) or any other suitable arrangement. This initiates power to the operational circuitry. After this power-up phase, the display panel 30 shows a default display of, for example, a wine within the word area. The illustrated default displays “PORT”. Selection of the wine type with which the device is to be used is achieved by activating an appropriate location. In the illustrated embodiment, this location is the control bottom 38 located at the top portion of the housing 10. As illustrated, control area 38 is in the form of a button, but other types of control interface areas are suitable, including keys, pads or buttons of any suitable type which will transmit an activation event, such as a touch of the finger, to a signal to the operational circuitry to make the desired change.

In the illustrated embodiment, touching the control button 38 changes the display in the wine selection panel 30, each touch moving the selection from one type to another. Thus, in the illustrated embodiment, activating the control button 38 will move the display from the default wording PORT to the next wording in the series, for example, ROSE. In accordance with the invention, this change in wine selection automatically activates the ideal optimal temperature which is programmed into the device for the thus selected wine. Accordingly, activation of the control button 38 will move from one wine selection to the next within the wine sequence.

In accordance with the invention, when the probe 12 is inserted into the wine, the user will be provided with a signal indicating whether the wine is at optimal serving temperature, or too warm or too cool. If the signal corresponds to the optimal temperature, the wine can be served. If too warm, the user could chill the wine, and then test again. If too cool, the user could warm the wine or let it sit until when tested again, the optimal temperature is achieved.

When it is desired to take a second, independent reading of that same wine, or if it is desired to check the temperature of a different wine, the user can activate the control button 38 one or more times. This will stop the illumination and flashing activities of the illustrated embodiment and clears the circuitry for fresh measurements.

In a preferred embodiment of the invention, the circuitry may include a time delay which automatically deactivates the circuit after a set period of time, i.e. in order to conserve battery power. Alternatively, a microswitch may be incorporated into the mount 14 to activate/deactivate the circuit in accordance with the position of the probe 12.

FIG. 4 discloses digital circuitry of the preferred embodiment which is discussed herein. Such digital circuitry can be embodied in a chip or other suitable carrier. As generally appreciated in the art, the switches depicted tie voltage levels to input pins of the chip. Power can be provided by a suitable battery. Two AAA dry cell batteries are usually satisfactory. It will be appreciated that, in this illustrated embodiment, appropriate electrical connections or other electronic communication is provided between the circuitry of FIG. 4 and the display panel 30 and LED's 32, 34, 36.

Turning to FIG. 5 which shows a flow chart which details the operation of a preferred embodiment. This illustrates a default setting of PORT for the display panel 30. As illustrated in FIG. 5, when the temperature of the wine is measured, this activates flashing of the wine temperature indicator, illustrated as one of the LED/word areas 32, 34, 36.

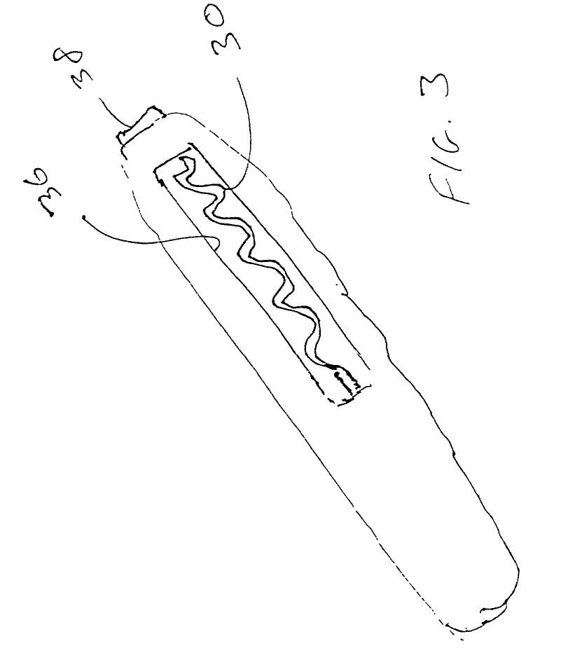

The device also includes a corkscrew 30 which is pivotally mounted on edge 32, opposite to that of the edge 34 in which the probe 12 is stored. In other words, a corkscrew 30 is pivotally mounted to housing 10, and can be conveniently folded into a groove 36 formed in edge 32. (FIG. 3). Optionally, a foil cutter 40, shown in phantom in FIG. 1, also may be pivotally mounted to housing 10.

It will be understood that the embodiments of the present invention which have been described are illustrative of some of the applications of the principles of the present invention. Numerous modifications may be made by those skilled in the art without departing from the true spirit and scope of the invention. For example, probe 12 could be slidably mounted in handle 10. Also, temperature probe 12 could be incorporated into the tip of a pressure or pump type cork extractor. This would permit one to measure the temperature of the wine by inserting the probe through the cork into the bottle without actually opening the bottle.

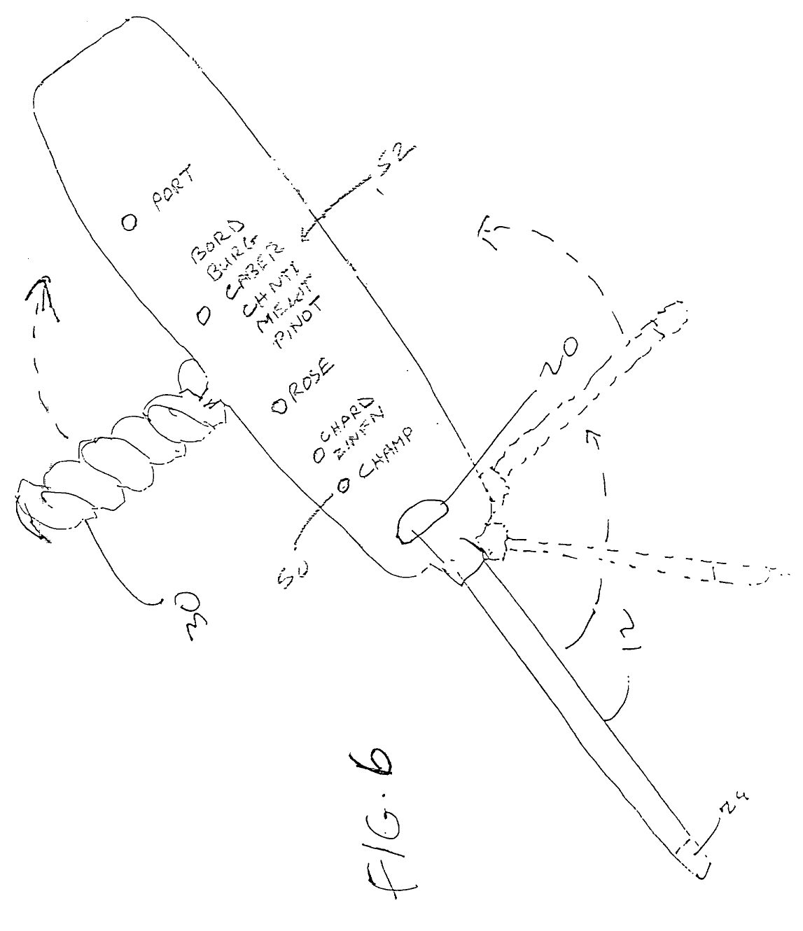

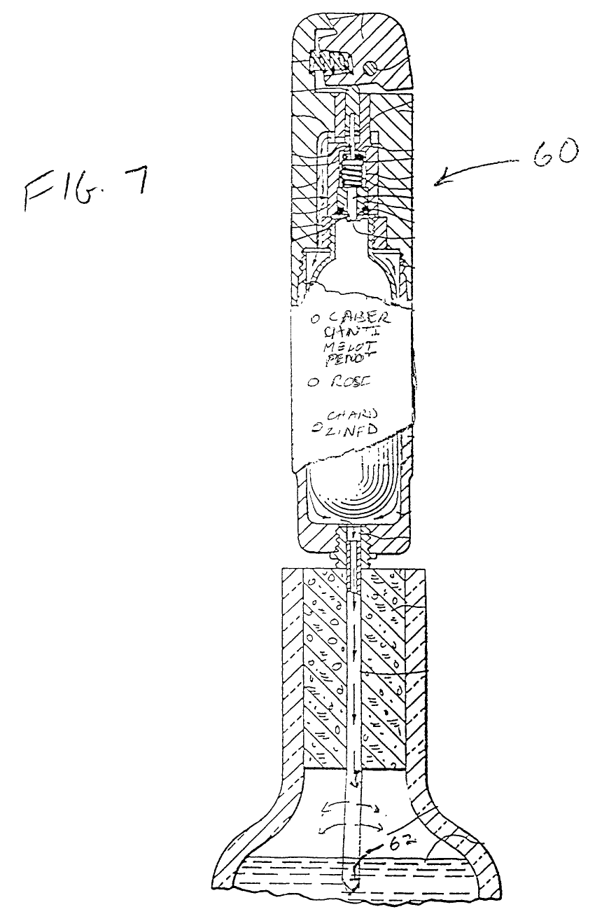

Various changes may be made in the above invention, without departing from the spirit and scope thereof. For example, referring to FIG. 6, in place of the wine selector and LCD display circuitry, a series of LCD's 50 may be provided on housing 10 adjacent a table of wine selections 52 listed in ascending optimal temperature order. In yet another embodiment of the invention, as shown in FIG. 7, which derives from FIG. 2 of U.S. Pat. No. 5,005,446, which is incorporated herein by reference, the cork extractor comprises a pressurized cork removal apparatus 60 such as described in U.S. Pat. No. 5,005,446 and in which the temperature sensor is carried on or built into the distal end of the gas injection needle 62. This construction is particularly advantageous in that it permits the user to measure wine temperature before uncorking the bottle. Still other changes may be made without departing from the spirit and scope of the invention.

1. An electronic wine thermometer comprising:
a housing;
a temperature probe extending from said housing;
a display panel associated with said housing and interactive with operational circuitry contained within said housing;
a heat sensor in said probe, said sensor being in electronic communication with said operational circuitry; and
a cork extractor on said housing.

2. A wine thermometer as claimed in claim 1, wherein said operational circuitry includes a control interface associated with said housing and interactive with said operational circuitry.

3. A wine thermometer according to claim 2, wherein said operational circuitry includes wine selection channel circuitry, and said operational circuitry further includes a message data channel circuitry for informing the user that a wine in contact with said temperature sensor has attained an optimal serving temperature.

4. A wine thermometer as claimed in claim 1, wherein indicia corresponding to a wine selection are carried on said housing.

5. A wine thermometer as claimed in claim 1, wherein said probe is stowable within said housing.

6. A wine thermometer as claimed in claim 1, wherein said wine extractor comprises a cork screw.

7. A wine thermometer as claimed in claim 6, wherein said cork screw is stowable within said housing.

8. A wine thermometer as claimed in claim 1, wherein said display panel comprises a plurality of LCD's.

9. A wine thermometer as claimed in claim 1, wherein said wine extractor comprises a pressurized cork extractor.

10. A wine thermometer as claimed in claim 9, wherein said pressurized cork extractor comprises a hollow needle, and wherein said heat sensor is carried on said hollow needle.

11. A wine thermometer as claimed in claim 10, wherein said heat sensor is built into a distal end of said hollow needle.

12. A wine thermometer as claimed in claim 1, and further comprising a foil cutter on said housing.

13. A wine thermometer as claimed in claim 3, wherein said display panel includes:
a first area for displaying indicia corresponding to a wine type selected in accordance with said wine selection channel circuitry; and
a second area for displaying indicia corresponding to a temperature which has been designated in association with said wine selection.

14. A wine thermometer as claimed in claim 3, wherein said data channel circuitry designates an ideal wine serving temperature for at least one wine type.

15. A wine thermometer according to claim 3, wherein said display panel includes indicia for at least one of warm, optimal and cool wine serving preferences.

16. A wine thermometer as claimed in claim 3, wherein said message data channel circuitry includes indicia for designating different wine types.

17. A wine thermometer as claimed in claim 3, wherein said wine selection channel circuitry and said operational circuitry combine to provide optimal serving temperature of
37-51° F. for Champagne;
40-54° F. for Chardonnay and Zinfandel;
44-58° F. for Rose;
56-69° F. for Bordeaux, Burgunday, Cabernet, Chianti, Merlot and Pinot; and
61-75° F. for Port.
